(19) United States
(12) Patent Application Publication
(10) Pub. No.: US 2005/0168656 A1
(43) Pub. Date: Aug. 4, 2005

(54) Method and system for quantized historical motion for motion detection in motion adaptive deinterlacer

(76) Inventors: Richard H. Wyman, Sunnyvale, CA (US); Brian Schoner, Fremont, CA (US)

Correspondence Address: MCANDREWS HELD & MALLOY, LTD, 500 WEST MADISON STREET, SUITE 3400, CHICAGO, IL, 60661, US

(21) Appl. No.: 10/945,817

(22) Filed: Sep. 21, 2004

Related U.S. Application Data
(60) Provisional application No. 60/540,575, filed on Jan. 30, 2004.

(51) Int. Cl. H04N 9/64

(52) U.S. Cl. 348/700

(57) ABSTRACT

In a video system, a method and system for quantized historical motion for motion detection in a motion adaptive deinterlacer are provided. A motion-adapted value for an output pixel in a current output field may be determined based on a current motion value and a historical motion value. The current motion value may be based on a pixel constellation and may be quantized once determined. The quantized current motion value may be stored and may be used to determine a quantized historical motion value for an output pixel in a field occurring after the current field. At least one quantized historical current motion value may be used to determine the quantized historical motion value for the output pixel in the current output field. The quantized historical motion value may be reverse quantized to determine the historical motion value for the output pixel.

### CROSS-REFERENCE TO RELATED APPLICATIONS/INCORPORATION BY REFERENCE

This patent application makes reference to, claims priority to and claims benefit from U.S. Provisional Patent Application Ser. No. 60/540,575, entitled “Quantized Historical Motion for Improved Motion Detection in Motion Adaptive Deinterlacer,” filed on Jan. 30, 2004.

This application makes reference to:
U.S. application Ser. No. ______ (Attorney Docket No. 15439US02) filed Sep. 21, 2004;
U.S. application Ser. No. 10/875,422 (Attorney Docket No. 15443US02) filed Jun. 24, 2004;
U.S. application Ser. No. ______ (Attorney Docket No. 15444US02) filed Sep. 21, 2004;
U.S. application Ser. No. ______ (Attorney Docket No. 15448US02) filed Sep. 21, 2004;
U.S. application Ser. No. 10/871,758 (Attorney Docket No. 15449US02) filed Jun. 17, 2004;
U.S. application Ser. No. ______ (Attorney Docket No. 15450US02) filed Sep. 21, 2004;
U.S. application Ser. No. ______ (Attorney Docket No. 15452US02) filed Sep. 21, 2004;
U.S. application Ser. No. ______ (Attorney Docket No. 15453US02) filed Sep. 21, 2004;
U.S. application Ser. No. ______ (Attorney Docket No. 15459US02) filed Sep. 21, 2004;
U.S. application Ser. No. 10/871,649 (Attorney Docket No. 15503US03) filed Jun. 17, 2004;
U.S. application Ser. No. ______ (Attorney Docket No. 15631US02) filed Sep. 21, 2004; and
U.S. application Ser. No. ______ (Attorney Docket No. 15632US02) filed Sep. 21, 2004.

The above stated applications are hereby incorporated herein by reference in their entirety.

### FIELD OF THE INVENTION

Certain embodiments of the invention relate to processing of video signals. More specifically, certain embodiments of the invention relate to a method and system for quantized historical motion for motion detection in motion detection deinterlacer.

### BACKGROUND OF THE INVENTION

In video system applications, a picture is displayed on a television or a computer screen by scanning an electrical signal horizontally across the screen one line at a time using a scanning circuit. The amplitude of the signal at any one point on the line represents the brightness level at that point on the screen. When a horizontal line scan is completed, the scanning circuit is notified to retrace to the left edge of the screen and start scanning the next line provided by the electrical signal. Starting at the top of the screen, all the lines to be displayed are scanned by the scanning circuit in this manner. A frame contains all the elements of a picture. The frame contains the information of the lines that make up the image or picture and the associated synchronization signals that allow the scanning circuit to trace the lines from left to right and from top to bottom.

There may be two different types of picture or image scanning in a video system. For some television signals, the scanning may be interlaced video format, while for some computer signals the scanning may be progressive or non-interlaced video format Interlaced video occurs when each frame is divided into two separate sub-pictures or fields. These fields may have originated at the same time or at subsequent time instances. The interlaced picture may be produced by first scanning the horizontal lines for the first field and then retracing to the top of the screen and then scanning the horizontal lines for the second field. The progressive, or non-interlaced, video format may be produced by scanning all of the horizontal lines of a frame in one pass from top to bottom.

In video compression, communication, decompression, and display, there has been for many years problems associated with supporting both interlaced content and interlaced displays along with progressive content and progressive displays. Many advanced video systems support either one format or the other format. As a result, deinterlacers, devices or systems that convert interlaced video format into progressive video format, became an important component in many video systems.

However, deinterlacing takes interlaced video fields and converts them into progressive frames, at double the display rate. Certain problems may arise concerning the motion of objects from image to image. Objects that are in motion are encoded differently in interlaced fields and progressive frames. Video images or pictures, encoded in interlaced video format, containing little motion from one image to another may be de-interlaced into progressive video format with virtually no problems or visual artifacts. However, visual artifacts become more pronounced with video images containing a lot of motion and change from one image to another, when converted from interlaced to progressive video format. As a result, some video systems were designed with motion adaptive deinterlacers.

Areas in a video image that are static are best represented with one approximation. Areas in a video image that are in motion are best represented with a different approximation. A motion adaptive deinterlacer attempts to detect motion so as to choose the correct approximation in a spatially localized area. An incorrect decision of motion in a video image results in annoying visual artifacts in the progressive output thereby providing an unpleasant viewing experience. Several designs have attempted to find a solution for this problem but storage and processing constraints limit the amount of spatial and temporal video information that may be used for motion detection.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for detecting motion using a pixel constellation. Aspects of the method may comprise defining an output pixel to be determined in a current output field and determining a value for the output pixel based on a current motion value and a historical motion value. The historical motion value and the current motion value may be used to determine a final motion value for the output pixel. The current motion value may be quantized and stored, and a quantized historical motion value may be reverse quantized to determine the historical motion value to be used for the output pixel. The quantized historical motion value may be determined from at least one quantized historical current motion value of a pixel in a present line in a field occurring prior to the current output field. The present line pixel may be at the same vertical and horizontal position as the output pixel or may be at the same horizontal position as the output pixel, depending on whether the prior field and the current output field are of the same type. The quantized historical motion value may be determined from the highest of the quantized historical current motion values being used from prior fields or may be determined from a weighted sum of the quantized historical current motion values being used from prior fields.

The current motion value for the output pixel may be based on a pixel constellation where all the pixels are in a similar horizontal position as the output pixel. The pixel constellation may comprise a pixel immediately above the output pixel, a pixel immediately below the output pixel, a pixel immediately before the output pixel, and a pixel immediately after the output pixel. The pixel constellation may also comprise a pixel above and a pixel below the output pixel in a second field occurring after the current field, and a pixel in the same vertical position as the output pixel in a third field occurring after the current field.

Another embodiment of the invention may provide a machine-readable storage, having stored thereon, a computer program having at least one code section executable by a machine, thereby causing the machine to perform the steps as described above for detecting motion using a pixel constellation.

Aspects of the system may comprise at least one processor that defines an output pixel to be determined in a current output field and determines a value for the output pixel based on a current motion value and a historical motion value. The processor may use the historical motion value and the current motion value to determine a final motion value for the output pixel. The current motion value may be quantized and stored into a memory, and a quantized historical motion value may be reverse quantized to determine the historical motion value to be used for the output pixel. The quantized historical motion value may be determined by the processor from at least one quantized historical current motion value of a pixel in a present line in a field occurring prior to the current output field. The present line pixel may be at the same vertical and horizontal position as the output pixel or may be at the same horizontal position as the output pixel, depending on whether the prior field and the current output field are of the same type. The processor may determine the quantized historical motion value from the highest of the quantized historical current motion values being used from prior fields or from a weighted sum of the quantized historical current motion values being used from prior fields.

In accordance with an aspect of the system, the current motion value may be based on a pixel constellation where all the pixels are in a similar horizontal position as said output pixel. The pixel constellation may comprise a pixel immediately above the output pixel, a pixel immediately below the output pixel, a pixel immediately before the output pixel, and a pixel immediately after the output pixel. The pixel constellation may also comprise a pixel above and a pixel below the output pixel in a second field occurring after the current field, and a pixel in the same vertical position as the output pixel in a third field occurring after the current field.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a block diagram of an exemplary architecture for positioning of a motion adaptive deinterlacer, in accordance with an embodiment of the invention.

FIG. 2 illustrates a block diagram of an exemplary flow of the algorithm which may be utilized by the MAD-3:2 in FIG. 1, in accordance with an embodiment of the invention.

FIG. 3 illustrates an exemplary motion adaptive deinterlacer, in accordance with an embodiment of the present invention.

FIG. 4 illustrates an exemplary input and output of a deinterlacer, in accordance with an embodiment of the present invention.

FIG. 5 illustrates an exemplary simple pixel constellation.

FIG. 6A illustrates an exemplary pixel constellation, in accordance with an embodiment of the present invention.

FIG. 6B illustrates exemplary positioning of constellation pixels in the current output frame, in accordance with an embodiment of the invention.

FIG. 7A illustrates an exemplary pixel constellation with locations for quantized historical current motion values, in accordance with an embodiment of the present invention.

FIG. 7B illustrates an exemplary pixel constellation with locations for quantized historical current motion values, in accordance with an embodiment of the present invention.

FIG. 8 is a flow diagram illustrating exemplary steps that may be used in determining the output pixel value based on quantized historical motion information, in accordance with an embodiment of the present invention.

### DETAILED DESCRIPTION OF THE INVENTION

Certain aspects of the invention may be found in a method and system for quantized historical motion for motion detection in a motion adaptive deinterlacer. The value for an output pixel in a current field may be based on at least one historical motion value from prior fields and on a current motion value. The current motion value may be quantized, stored, and then reverse quantized to be used as a historical motion value in a subsequent field. By quantizing motion information from prior fields, it may be possible to provide fewer visual artifacts, and a more pleasant viewing experience, in the progressive output of a motion adaptive deinterlacer without the need for large storage and/or memory requirements.

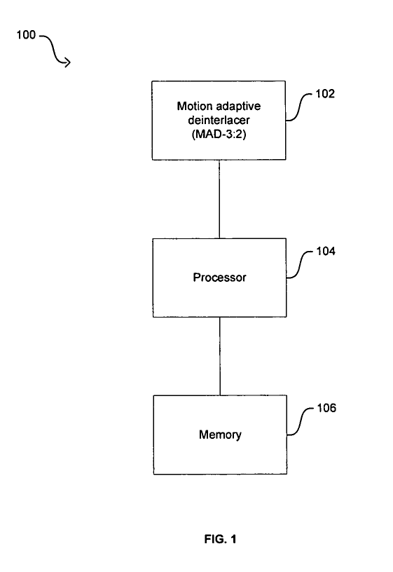

FIG. 1 illustrates a block diagram of an exemplary architecture for positioning of a motion adaptive deinterlacer, in accordance with an embodiment of the invention. Referring to FIG. 1, the deinterlacer system 100 may comprise a motion adaptive deinterlacer (MAD-3:2) 102, a processor 104, and a memory 106. The MAD-3:2 102 may comprise suitable logic, code, and/or circuitry that may be adapted to deinterlace video fields. The processor 104 may comprise suitable logic, code, and/or circuitry that may be adapted to control the operation of the MAD-3:2 102, to perform the operation of the MAD-3:2 102, and/or to transfer control information and/or data to and from the memory 106. The memory 106 may comprise suitable logic, code, and/or circuitry that may be adapted to store control information, data, information regarding current video fields, and/or information regarding prior video fields.

The MAD-3:2 102 may be capable of reverse 3:2 pull-down and 3:2 pull-down cadence detection which may be utilized in a video network (VN). The MAD-3:2 102 may be adapted to acquire interlaced video fields from one of a plurality of video sources in the video network and convert the acquired interlaced video fields into progressive frames, at double the display rate, in a visually pleasing manner.

The MAD-3:2 102 may be adapted to accept interlaced video input and to output deinterlaced or progressive video to a video bus utilized by the video network. The MAD-3:2 102 may accept up to, for example, 720×480i and produce, for example, 720×480p in the case of NTSC. For PAL, the motion adaptive deinterlacer (MAD) may accept, for example, 720×576i and produce, for example, 720×576p. Horizontal resolution may be allowed to change on a field by field basis up to, for example, a width of 720. The MAD-3:2 102 may be adapted to smoothly blend various approximations for the missing pixels to prevent visible contours produced by changing decisions. A plurality of fields of video may be utilized to determine motion. For example, in an embodiment of the invention, five fields of video may be utilized to determine motion. The MAD-3:2 102 may produce stable non-jittery video with reduced risk of visual artifacts due to motion being misinterpreted while also providing improved still frame performance. The MAD-3:2 102 may also provide additional fields per field type of quantized motion information which may be selectable in order to reduce the risk of misinterpretation. For example, up to three (3) additional fields or more, per field type, of quantized motion information may optionally be selected in order to reduce risk of misinterpreted motion even further. This may provide a total historical motion window of up to, for example, 10 fields in a cost effective manner. Integrated cross-chrominance removal functionality may be provided, which may aid in mitigating or eliminating NTSC comb artifacts. A directional compass filtering may also be provided that reduces or eliminates jaggies in moving diagonal edges. The MAD-3:2 102 may provide reverse 3:2 pull-down for improved quality from film based sources. The MAD-3:2 102 may also be adapted to support a variety of sources.

In operation, the MAD-3:2 102 may receive interlaced fields and may convert those deinterlaced fields into progressive frames, at double the display rate. A portion of the information regarding fields that occurred prior to the current field being deinterlaced may be stored locally in the MAD-3:2. A portion of the information regarding fields that occurred after the current field being deinterlaced may also be stored locally in the MAD-3:2. A remaining portion of the information regarding fields that occurred prior to and after the current field may be stored in the memory 106.

The processor 104 may control the operation of the MAD-3:2 102, for example, it may select from a plurality of deinterlacing algorithms that may be provided by the MAD-3:2 102. The processor 104 may modify the MAD-3:2 102 according to the source of video fields. Moreover, the processor 104 may transfer to the MAD-3:2 102, information stored in the memory 106. The processor 104 may also transfer to the memory 106 any field-related information not locally stored in the MAD-3:2 102. The MAD-3:2 102 may then use information from the current field, information from previously occurring fields, and information from fields that occurred after the current field, to determine a motion-adapted value of the output pixel under consideration.

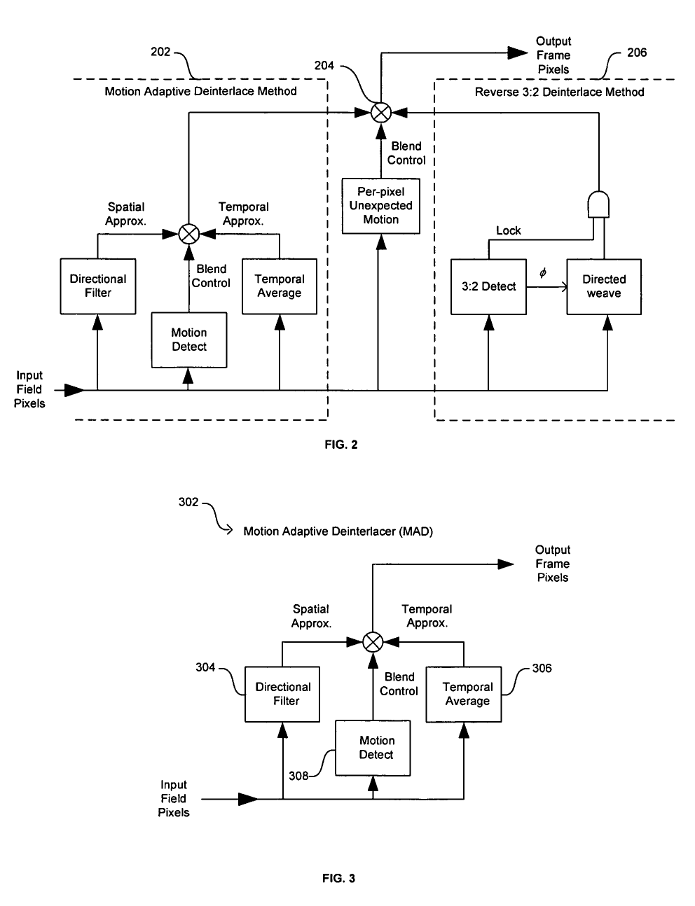

FIG. 2 illustrates a block diagram of an exemplary flow of the algorithm which may be utilized by the MAD-3:2 in FIG. 1, in accordance with an embodiment of the invention. Referring to FIG. 2, there is shown a data flow corresponding to the algorithm utilized for deinterlacing the luma (Y) component of video. The algorithm may effectively be divided into two halves. For example, diagrammed on the left of FIG. 2 is the motion adaptive deinterlacer (MAD) method 202 of deinterlacing and on the right, there is shown the reverse 3:2 pulldown method 206 of deinterlacing. For every output pixel, the MAD method 202, the reverse 3:2 pulldown method 206, or a blend 204 of the MAD method 202 and the reverse 3:2 pulldown method 206 may be utilized in order to determine a motion-adapted value of the output pixel under consideration.

U.S. Patent Application Ser. No. 60/540,614 filed Jan. 30, 2004 entitled “Improved Correlation Function for Signal Detection, Match Filters, and 3:2 Pulldown Detect,” discloses an exemplary reverse 3:2 pulldown method 206 of deinterlacing which may be utilized in connection with the present invention. Accordingly, U.S. Patent Application Ser. No. 60/540,614 filed Jan. 30, 2004 is hereby incorporated herein by reference in its entirety.

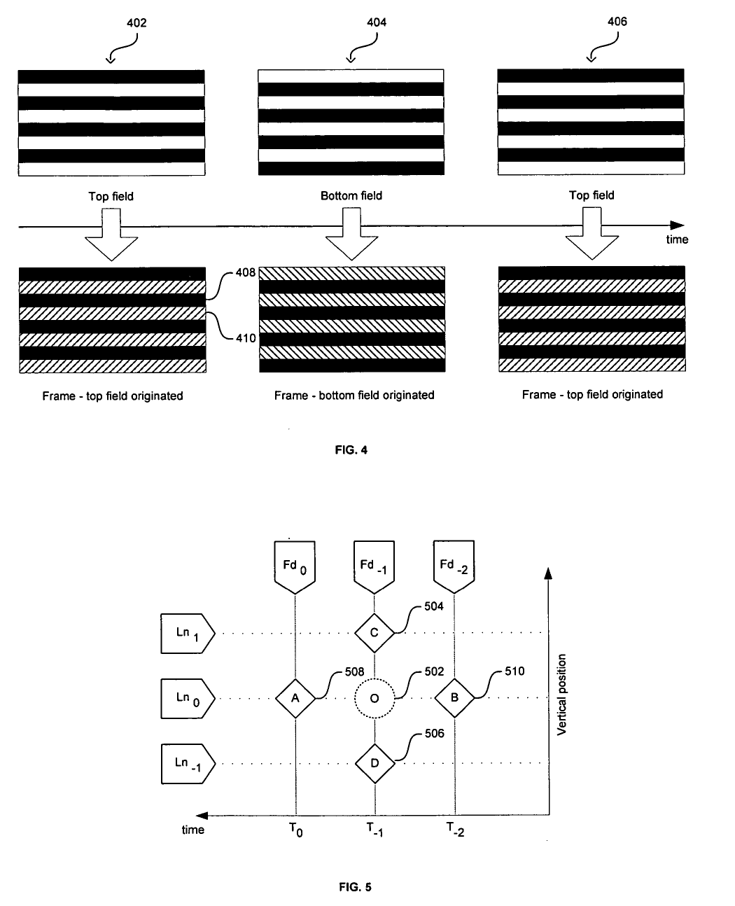

FIG. 3 illustrates an exemplary motion adaptive deinterlacer, in accordance with an embodiment of the present invention. The motion adaptive deinterlacer (MAD) 302 may comprise a directional filter 304, a temporal average 306, and a blender 308. The MAD 302 may comprise suitable logic, code, and/or circuitry that may be adapted for performing the MAD method 202 of deinterlacing shown in FIG. 2. The processor 104 may be adapted to perform the operation of the MAD 302. The MAD 302 may comprise local memory for storage of data and/or instructions. The directional filter 304 may comprise suitable logic, code, and/or circuitry that may be adapted for spatially approximating the value of the output pixel. The temporal average 306 may comprise suitable logic, code, and/or circuitry that may be adapted for temporal approximation of the value of the output pixel. The blender 308 may comprise suitable logic, code, and/or circuitry that may be adapted to combine the temporal and spatial approximations of the value of the output pixel.

In operation, the MAD 302 may receive input field pixels from an interlaced video field and convert them into output frame pixels in a progressive frame, at double the display rate. The horizontal resolution of the input to the MAD 302 may change on a field-by-field basis. The MAD 302 may utilize a motion adaptive algorithm that may smoothly blend various approximations for the output pixels to prevent visible contours, which may be produced by changing decisions. In an embodiment of the present invention, it may be necessary to determine the amount of motion around each output pixel, to use an appropriate approximation for the output pixel. The MAD 302 may utilize the directional filter 304, the temporal average 306, and the blender 308 to obtain a motion-adapted value for the output pixel that is visually pleasing.

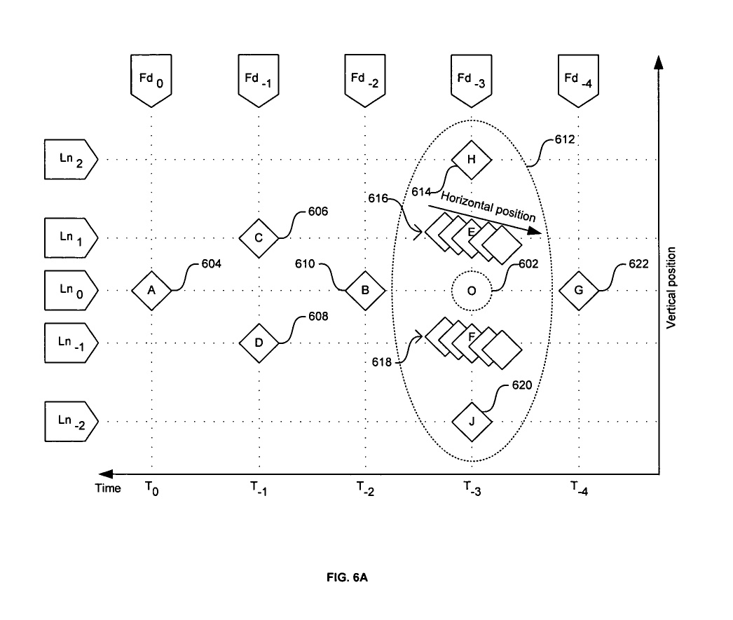

FIG. 4 illustrates an exemplary input and output of a deinterlacer, in accordance with an embodiment of the present invention. Referring to FIG. 4, three fields are presented to the deinterlacer. The first field 402 is a top field, the second field 404 is a bottom field, and the third field 406 is a top field again. The first field 402 may be a bottom or top field, and the sequence of fields may alternate between top and bottom as appropriate depending on the first field 402. The deinterlacer may take the present lines in the field (black-colored lines in FIG. 4) and fill in the absent lines (clear lines in FIG. 4) to produce an output frame. The process of deinterlacing may be seen as taking one present line of pixels from the source field and producing two output lines of pixels. One line is the line that came from the source field and may be called the “present” line (black). An exemplary present line 408 is shown in FIG. 4 for the frame that originated from the first field 402. The other line is the line that needs to be created and may be called the “absent” line (hatched lines). An exemplary absent line 410 is shown in FIG. 4 for the frame that originated from the first field 402. This double output line pattern may then repeat to create the output frame. The pixels of the absent line may be computed using a deinterlacing procedure in accordance with an embodiment of the present invention. A line of present pixels may be output in parallel with a line of absent pixels. The two lines of output may make up the progressive frame lines.

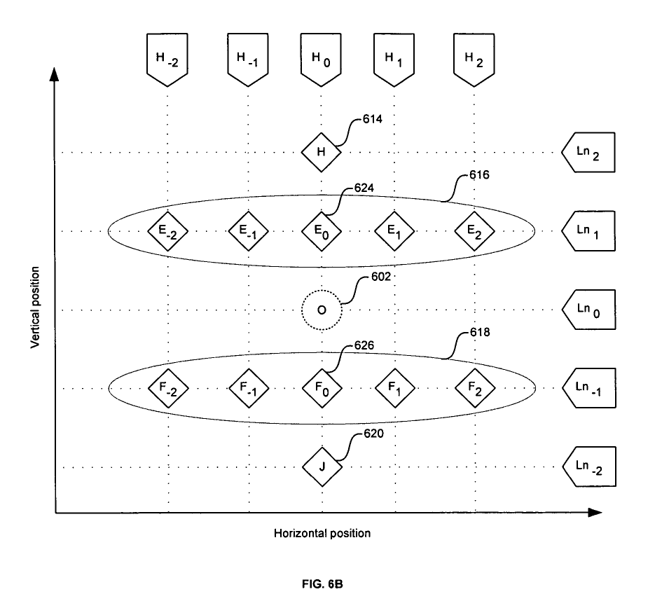

FIG. 5 illustrates an exemplary simple pixel constellation. Referring to FIG. 5, the current output field under consideration is a field Fd₋₁ at time T₋₁ and the current absent line to be determined is a line Ln₀. The most recent field to occur is a field Fd₀ at time T₀ and the earliest field shown is a field Fd₋₂ at time T₋₂. Generally, except for the first and last output lines of a frame, there will always be a present line Ln₁ of known pixels above and another present line Ln₋₁ of known pixels below the absent line Ln₀ to be determined. Looking forward and backwards in time to the fields Fd₀ and Fd₋₂ adjacent to the field Fd₋₁, there will be present lines of known pixels at the same vertical position as the absent line Ln₀ currently being determined. Referring back to FIG. 5, each output pixel (O) 502 to be calculated in the absent line Ln₀, may be treated individually. Then, there will be one pixel above (C) 504 in present line Ln₁ of field Fd₋₁, one pixel below (D) 506 in present line Ln₁ of field Fd₋₁, one pixel occurring forward in time (A) 508 in present line Ln₀ of field Fd₀, and one pixel occurring backwards in time (B) 510 in present line Ln₀ of field Fd₋₂.

Each output frame generated by deinterlacing may have a height H and a width W, and for equations hereinafter, t will represent the time index, i will represent the height index where 0≦i<H, and j will represent the width index where 0≦j<W. For an output frame originated by a top field such as, for example, top field 402 or 406 in FIG. 4, when i MOD 2=0, the pixels in a line are provided from a present line in a source field, and when i MOD 2=1 the line corresponds to an absent line and the pixels in that line are determined. Conversely, in an output frame originated by a bottom field such as, for example, bottom field 404 in FIG. 4, when i MOD 2=1 the pixels in a line are provided from a present line in a source field, and when i MOD 2=0 the line corresponds to an absent line and the pixels in that line are determined. Considering just luma (Y) for the bottom field originated example, the output pixel O 502 to be created is such that:
O=Y_{O}=Y(t,i,j) with 0≦i<H, iMOD2≡0 and 0≦j<W
The other pixels of the constellation in FIG. 5, pixel A 508, pixel B 510, pixel C 504, and pixel D 506, which may be used to create the output pixel O 502, may then be referenced with respect to the location of output pixel O 502.
A=Y_{A}=Y(t−1,i,j)
B=Y_{B}=Y(t+1,i,j)
C=Y_{C}=Y(t,i−1,j)
D=Y_{D}=Y(t,i+1,j)

A motion adaptive deinterlacer creates an estimated value of output pixel O 502 by determining how much “motion” is present. Motion in this context refers to a pixel in a given spatial location changing over time. The motion may be due to, for example, objects moving or lighting conditions changing. It may be determined that there is little or no motion, then the best estimate for output pixel O 502 would be provided by pixel A 508 and pixel B 510, which is known as “weave” in graphics terminology. On the other hand, it may be determined that there is significant motion, then pixel A 508 and pixel B 510 no longer provide a good estimate for output pixel O 502. In this case, a better estimate would be provided by pixel C 504 and pixel D 506, which is known as “bob” in graphics terminology. This yields the following equations:

$$\begin{matrix}O = \frac{A + B}{2} when motion is small ( temporal average \text{/} weave ) \\ O = \frac{C + D}{2} when motion is large ( spatial average \text{/} b o b )\end{matrix}$$

And motion may be determined by the following equation:
motion=abs(A−B)
If the values of pixel A 508 and B 510 are similar, the value determined for the motion would be small. If the values of pixel A 508 and B 510 are not very similar, the value determined for the motion would be large. The value determined for the motion may then be compared to a motion threshold to determine whether a temporal average or a spatial average approach is appropriate when determining the value of output pixel O 502.

In practice, the decision of using the threshold between the two approximations for output pixel O 502 may be visible in areas where one pixel may choose one method and an adjacent pixel may choose the other. Additionally, using only pixel A 508 and B 510 to determine motion may result in missing motion in certain situations such as, for example, when objects have texture and move at such a rate that the same intensity from the texture lines up with both pixel A 508 and B 510 repeatedly over time—the object may be moving, but as seen with the bunkered view of just examining the intensity at pixel A 508 and B 510, the motion may not be seen. This is known as “motion aliasing” and results in a weave or temporal averaging being performed when the situation may actually require a bob or spatial averaging.

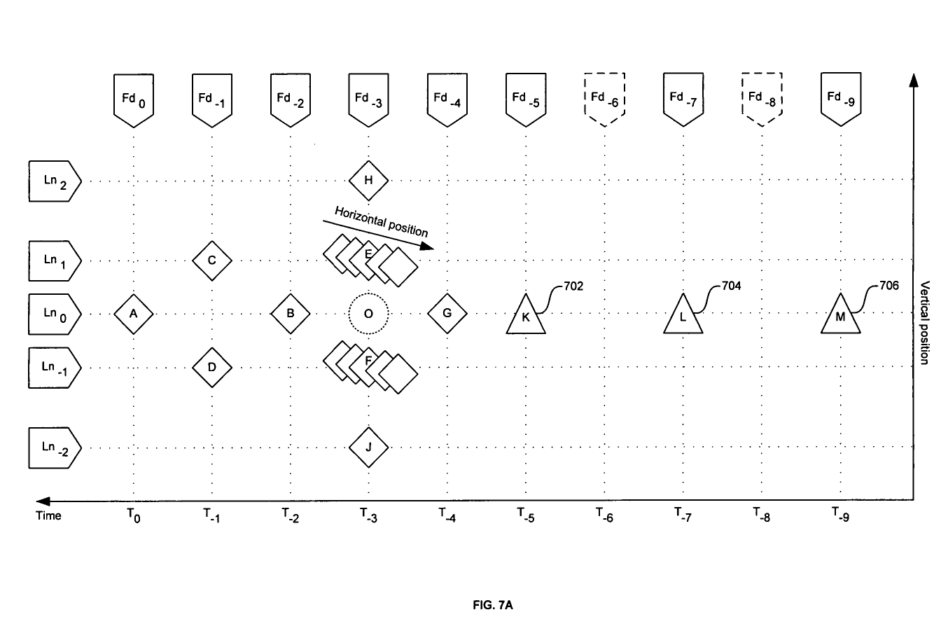

FIG. 6A illustrates an exemplary pixel constellation, in accordance with an embodiment of the present invention. Referring to FIG. 6A, the pixel constellation may comprise a plurality of pixels 612 in current output field Fd₋₃, a pixel (A) 604 in present line Ln₀ of input field Fd₀, a pixel (C) 606 in present line Ln₁ of field Fd₋₁, a pixel (D) 608 in present line Ln₋₁ of field Fd₋₁, a pixel (B) 610 in present line Ln₀ of field Fd₋₂, and a pixel (G) 622 in present line Ln₀ of field Fd₋₄. The plurality of pixels 612 in field Fd₋₃ may comprise an output pixel (O) 602 in absent line Ln₀, a pixel (H) 614 in present line Ln₂, a plurality of pixels (E) 616 in present line Ln₁, a plurality of pixels (F) 618 in present line Ln₋₁, and a pixel (J) 620 in present line Ln₋₂.

FIG. 6B illustrates an exemplary positioning of constellation pixels in the current output frame, in accordance with an embodiment of the invention. Referring to FIG. 6B, the plurality of pixels E 616 in present line Ln₁ may comprise a pixel E₀ 624 immediately above the output pixel O 602, a pixel E₋₁ and a pixel E₋₂ to the left of the pixel E₀ 624, and a pixel E₁ and a pixel E₂ to the right of the pixel E₀ 624. Additional pixels to the right and left of pixel E₀ 624 may be used. Moreover, additional pixels may be used with pixel (H) 614 in present line Ln₂. The plurality of pixels F 618 in present line Ln₋₁ may comprise a pixel F₀ 626 immediately below the output pixel O 602, a pixel F₋₁ and a pixel F₋₂ to the left of the pixel F₀ 626, and a pixel F₁ and a pixel F₂ to the right of the pixel F₀ 626. Additional pixels to the right and left of pixel F₀ 626 may be used. Moreover, additional pixels may be used with pixel (J) 620 in present line Ln₋₂.

The pixel constellation shown in FIGS. 6A-6B may reduce the occurrence of motion aliasing by using information from additional fields. In an embodiment of the present invention, the constellation may also improve spatial averaging by including additional horizontal pixels, for example, the plurality of pixels E 616 and the plurality of pixels F 618 in present lines L₁ and L₋₁ of current field Fd₋₃, when determining the value of output pixel O 602. In an embodiment of the present invention, time T₀ is shown on the left; and fields to the right of T₀ are back in time from that reference point.

The following equations define a shorthand notation used hereinafter:
A=Y_{A}=Y(t,i,j)
B=Y_{B}=Y(t−2,i,j)
G=Y_{G}=Y(t−4,i,j)
C=Y_{C}=Y(t−1,i−1i,j)
D=Y_{D}=Y(t−1,i+1,j)
Eₖ=Y_{E}_{ₖ}=Y(t−3,i−1,j+k) for −2≦k≦2
H=Y_{H}=Y(t−3,i−3,j)
Fₖ=Y_{F}_{ₖ}=Y(t−3,i+1,j+k) for −2≦k≦2
J=Y_{J}=Y(t−3,i+3,j)
For example, with reference to the pixel constellation given in FIGS. 6A-6B, pixel A 604 may represent the value of luma (Y) at given row or vertical position i, column or horizontal position j, and field time t. The row or vertical position i may also refer to the line in the field. The other pixels in the constellation may be positioned relative to pixel A 604. For example, pixel G 622 is located at the same row and column as pixel A 604 but in a field that occurred four fields prior to the field with pixel A 604.

In an embodiment of the present invention, the current motion, mₐ, around the output pixel O 602 may be determined using pixels A 604 through G 622 according to the following equations, in which only E₀ and F₀ may be used from the plurality of pixels E 616 and the plurality of pixels F 618 since they have the same horizontal position as the other pixels in the constellation:
mₜ=MAX<A,B,G>−MIN<A,B,G>
mₛ=MIN<|E₀−C|,|F₀−D|>
mₐ=MAX<mₜ,mₛ>
where mₜ is the current temporal motion and mₛ is the current spatial motion. The pattern of pixels used with the MAX and MIN functions may maximize the amount of motion which is detected to prevent motion aliasing and may provide a localized region of detection so that video containing mixed still and moving material may be displayed as stable, non-jittering pictures.

The current motion, mₐ, for the output pixel O 602 may be stored so that it may be retrieved for use in determining a final motion, m_{f}, value for an output pixel in a field that may occur after the current field. The current motion, mₐ, rather than the final motion, m_{f}, is used to prevent an infinite loop. The current motion, mₐ, may be quantized before storage to reduce the memory requirements of the MAD-3:2 102 and/or the memory 106. The number of quantization bits and the range that may be assigned to each of the plurality of quantization levels may be programmable. When the current motion value lies on a quantization level boundary, the current motion value may be assigned, for example, to the lower quantization number so as to err on the side of still. Quantization may also be performed by a look-up table, where, for example, the current motion value may be mapped to a quantized value in the look-up table. The following is an exemplary 2-bit quantization for an 8-bit motion value using quantization level ranges:

$${Q}_{out} = \{ \begin{matrix}{2}^{′} b00 & when & 0 \leq {m}_{a} < 16 \\ {2}^{′} b01 & when & 16 \leq {m}_{a} < 64 \\ {2}^{′} b10 & when & 64 \leq {m}_{a} < 128 \\ {2}^{′} b11 & when & 128 \leq {m}_{a} < 256\end{matrix}$$

where Qₒᵤₜ corresponds to the quantized version of mₐ.

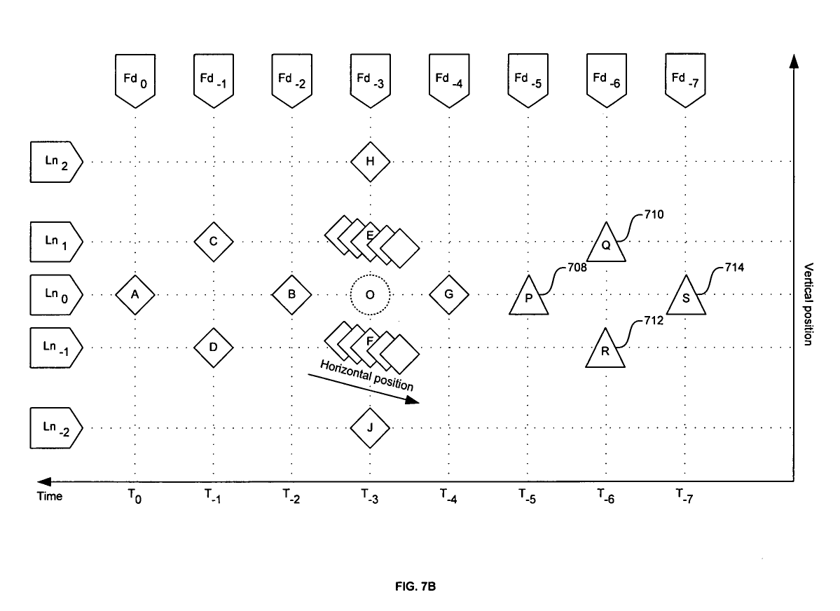

FIG. 7A illustrates an exemplary pixel constellation with locations for quantized historical current motion values, in accordance with an embodiment of the present invention. Referring to FIG. 7A, locations K 702, L 704, and M 706 are not actual pixels, but instead, they represent the spatial and temporal locations of historical current motion values that may be used to determine the value of output pixel O 602. These historical current motion values may have been quantized before storage. In this embodiment, the gaps in historical current motion information at field Fd₋₆ and field Fd₋₈ result from including historical current motion information from fields of the same type (top/bottom) as the current output field. The coefficient Q may be used to correspond to a quantized version of the historical determination of current motion at that spatial/temporal location. The choice to use a quantized representation of the motion allows for an increased range in time when determining motion, with minimal cost in gates or bandwidth. The benefit being improved quality due to a reduced occurrence of motion aliasing.

The following equations may be used to define a shorthand notation used hereinafter to indicate the position of locations K 702, L 704, and M 706 relative to pixel A 604:
K=Q_{K}=Q(t−5,i,j)
L=Q_{L}=Q(t−₇,i,j)
M=Q_{M}=Q(t−₉,i,j)
where Q_{K}, Q_{L}, and Q_{M} correspond to the quantized version of the historical current motion values at locations K 702, L 704, and M 706 respectively.

The quantized historical motion value for use in determining the value of the output pixel O 602 may be given by Qₕ=MAX<K,L,M>, where if the values of K 702, L 704, and M 706 are, for example, 2-bit quantized numbers, then the value of Qₕ will also be a 2-bit quantized number. In another embodiment of the invention, the quantized historical motion value may be determined from a weighted sum of the quantized historical current motion values for locations K 702, L 704, and M 706, where the weighing coefficients may be used, for example, to provide a bias towards more recent results. An example of a weighted sum may be as follows:
Qₕ=aₖK+b_{L}L+c_{M}M
where a_{K}, b_{L}, and c_{M} are the coefficients for the quantized historical current motion values in locations K 702, L 704, and M 706 respectively.

FIG. 7B illustrates an exemplary pixel constellation with locations for quantized historical current motion values, in accordance with an embodiment of the present invention. Referring to FIG. 7B, in a different embodiment of the invention, locations P 708, Q 710, R 712, and S 714 represent the spatial and temporal locations of historical current motion values that may be used to determine the value of output pixel O 602. The following equations may be used to define a shorthand notation used hereinafter to indicate the position of locations P 708, Q 710, R 712, and S 714 relative to pixel A 604:
P=Q_{P}=Q(t−5,i,j)
Q=Q_{Q}=Q(t−6,i−1,j)
R=Q_{R}=Q(t−6,i+1,j)
S=Q_{M}=Q(t−7,i,j)
where Q_{P}, Q_{Q}, Q_{R}, and Q_{S} correspond to the quantized version of the historical current motion values at locations P 708, Q 710, R 712, and S 714 respectively.

The quantized historical motion value for use in determining the value of the output pixel O 602 may be given by Qₕ=MAX<P, MIN(Q,R),S>, where if the values of P 708, Q 710, R 712, and S 714 are, for example, 2-bit quantized numbers, then the value of Qₕ will also be a 2-bit quantized number. In another embodiment of the invention, the quantized historical motion value may be determined from a weighted sum of the quantized historical current motion values for locations P 708, Q 710, R 712, and S 714, where the weighing coefficients may be used, for example, to provide a bias towards more recent results. An example of a weighted sum may be as follows:
Qₕ=aₚP+b_{Q}Q+c_{R}R+d_{S}S
where a_{P}, b_{Q}, c_{R}, and ds are the coefficients for the quantized historical current motion values in locations P 708, Q 710, R 712, and S 714 respectively.

The mapping of the quantized historical motion value, Qₕ, to a historical motion value, mₕ, may be programmable and may be based on a look-up table. The bit precision of the historical motion value may also be programmable. For example, a conversion from the 2-bit quantized historical motion value for output pixel O 602, Qₕ, to a 7-bit historical motion value, mₕ, may be as follows:

$${m}_{h} = \{ \begin{matrix}0 & when & {Q}_{h} = {2}^{′} b00 \\ 16 & when & {Q}_{h} = {2}^{′} b01 \\ 64 & when & {Q}_{h} = {2}^{′} b10 \\ 128 & when & {Q}_{h} = {2}^{′} b11\end{matrix}$$

The final motion, m_{f}, for output pixel O 602 may be determined from the current motion, mₐ, and the historical motion, mₕ, as follows:
m_{f}=MAX<mₐ, mₕ>

The estimated luma value, O_{Y}, for output pixel O 602 may be determined as follows:

$$\begin{matrix}{T}_{a} = \frac{A + B}{2} \\ {S}_{a} = \frac{A + B}{2} \\ X = {T}_{a} , Y = {S}_{a} , M = {m}_{f} \\ Z = Y - X \\ {M}_{L} = MAX \{ MIN 〈 M , Z 〉 , - M \} \\ {O}_{Y} = X + {M}_{L}\end{matrix}$$

where Tₐ is the temporal average approximation, Sₐ is the spatial average approximation, X and Y represent the two approximations which may be used for output pixel O 602, Z is the range of values for output pixel O 602, M is the measure of motion which indicates where within the range Z the value of the output pixel O 602 will be, M_{L} is the limited value of M so that it does not extend beyond the value of Y, and O_{Y} is the motion-adapted luma value of output pixel O 602.

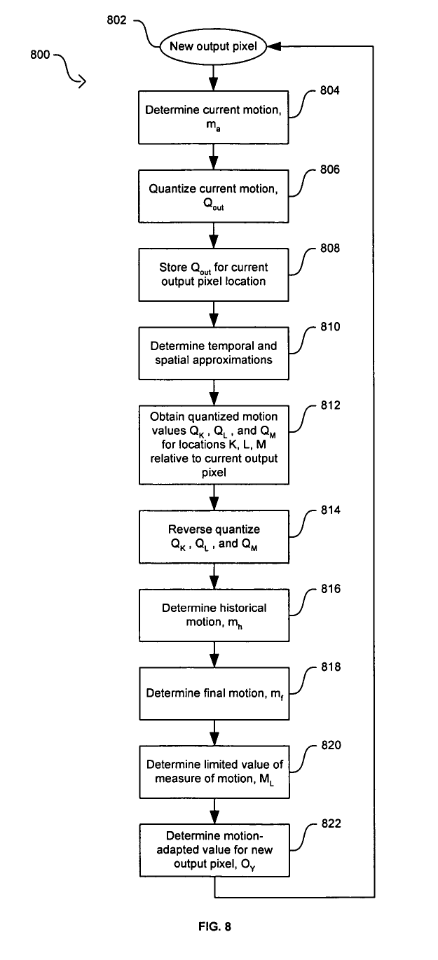

FIG. 8 is a flow diagram illustrating exemplary steps that may be used in determining the output pixel value based on quantized historical motion information, in accordance with an embodiment of the present invention. Referring to FIG. 8, the flow diagram 800 starts with a new output pixel 802 to be determined for deinterlacing. In step 804, the MAD 302 in FIG. 2 may determine the current motion value, mₐ, based on the highest of the current temporal motion value, mₜ, and the current spatial motion value, mₛ. In step 806, the MAD 302 may quantize the current motion value determined in step 804. The level of quantization in step 806 may be determined and/or modified by the processor 104 in FIG. 1. The threshold of quantization may be selected so that a value in the boundary between two quantization levels may be placed in the lower quantization level. In step 808, the MAD 302 may store into local memory and/or into the memory 106 in FIG. 1, the quantized current motion value for the output pixel under consideration. In step 810, the MAD 302 may determine the temporal average approximation, Tₐ, and the spatial average approximation, Sₐ, based on the value of the pixels in the pixel constellation shown in FIG. 6A. The value of the pixels that do not correspond to the most recently occurring field may be stored locally in the MAD 302 and/or may be stored in the memory 106.

In step 812, the MAD 302 may transfer from local memory and/or from the memory 106, the stored values Q_{K}, Q_{L}, and Q_{M} that correspond to the quantized version of the historical motions at locations K 702, L 704, and M 706 respectively. In step 814, the MAD 302 may reverse quantize the values Q_{K}, Q_{L}, and Q_{M} to be used in determining the value of the new output pixel. The reverse quantization in step 814 may be based on a different number of quantization levels than the quantization operation in step 806. Moreover, the threshold value between quantization levels may also be different than those in the quantization operation in step 806. Selection of the number of levels and the threshold value between levels may be system dependent and may be performed by the processor 104.

In step 816, the MAD 302 may determine the historical motion value, mₕ, for the new output pixel based on the highest value of the reverse quantized historical motion values determined in step 814. In step 818, the MAD 302 may determine a final motion value, m_{f}, for the new output pixel based on the highest value of the current motion value, mₐ, determined in step 804 and the historical motion value, mₕ, determined in step 816. In step 820, the MAD 320 may determine the limited value of the measure of motion, M_{L}, for the motion values that range between the temporal average approximation, Tₐ, and the spatial average approximation, Sₐ, determined in step 810. In step 822, the MAD 320 may determine the motion-adapted luma value, O_{Y} for the new output pixel based on the limited value of the measure of motion, M_{L}, and the temporal average approximation, Tₐ.

By quantizing historical motion information from prior fields and by using current motion information based on the pixel constellation, it may be possible to provide fewer visual artifacts, and a more pleasant viewing experience, in the progressive output of a motion adaptive deinterlacer without the need for large storage and/or memory requirements.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for detecting motion using a pixel constellation, the method comprising:
defining an output pixel to be determined in a current output field; and
determining a value for said output pixel based on:
a current motion value for said output pixel; and
a historical motion value for said output pixel.

2. The method according to claim 1, further comprising quantizing and storing said current motion value for said output pixel.

3. The method according to claim 1, further comprising determining said historical motion value for said output pixel by reverse quantizing a quantized historical motion value for said output pixel.

4. The method according to claim 3, further comprising determining said quantized historical motion value for said output pixel based on at least one quantized historical current motion value for a pixel in a present line in a field occurring prior to said current output field.

5. The method according to claim 3, wherein said present line pixel is at the same vertical and horizontal positions as said output pixel.

6. The method according to claim 3, wherein said present line pixel is immediately above or immediately below the vertical position of said output pixel and it is at the same horizontal position as said output pixel.

7. The method according to claim 3, further comprising determining said quantized historical motion value for said output pixel based on a highest of said at least one quantized historical current motion value for said present line pixel in said field occurring prior to said current output field.

8. The method according to claim 3, further comprising determining said quantized historical motion value for said output pixel based on a weighted sum of said at least one quantized historical current motion value for said present line pixel in said field occurring prior to said current output field.

9. The method according to claim 1, further comprising determining said output pixel value based on a final motion value for said output pixel.

10. The method according to claim 1, further comprising determining a final motion value for said output pixel based on said historical motion value for said output pixel and said current motion value for said output pixel.

11. The method according to claim 1, further comprising determining said current motion value for said output pixel based on a pixel constellation where all pixels are in a similar horizontal position as said output pixel.

12. The method according to claim 11, wherein said pixel constellation comprises:
a pixel in said current output field that is in a present line immediately above said output pixel;
a pixel in said current output field that is in a present line immediately below said output pixel;
a pixel that is in the same vertical position as said output pixel in a field occurring immediately prior to said current output field;
a pixel that is in the same vertical position as said output pixel in a field occurring immediately after said current output field;
a pixel that is in a present line immediately above the vertical position of said output pixel in a second field occurring after said current output field;
a pixel that is in a present line immediately below the vertical position of said output pixel in a second field occurring after said current output field; and
a pixel that is in the same vertical position as said output pixel in a third field occurring after said current output field.

13. A machine-readable storage having stored thereon, a computer program having at least one code section for detecting motion using a pixel constellation, the at least one code section being executable by a machine for causing the machine to perform steps comprising:
defining an output pixel to be determined in a current output field; and
determining a value for said output pixel based on:
a current motion value for said output pixel; and
a historical motion value for said output pixel.

14. The machine-readable storage according to claim 13, further comprising code for quantizing and storing said current motion value for said output pixel.

15. The machine-readable storage according to claim 13, further comprising code for determining said historical motion value for said output pixel by reverse quantizing a quantized historical motion value for said output pixel.

16. The machine-readable storage according to claim 15, further comprising code for determining said quantized historical motion value for said output pixel based on at least one quantized historical current motion value for a pixel in a present line in a field occurring prior to said current output field.

17. The machine-readable storage according to claim 15, wherein said present line pixel is at the same vertical and horizontal positions as said output pixel.

18. The machine-readable storage according to claim 15, wherein said present line pixel is immediately above or immediately below the vertical position of said output pixel and it is at the same horizontal position as said output pixel.

19. The machine-readable storage according to claim 15, further comprising code for determining said quantized historical motion value for said output pixel based on a highest of said at least one quantized historical current motion value for said present line pixel in said field occurring prior to said current output field.

20. The machine-readable storage according to claim 15, further comprising code for determining said quantized historical motion value for said output pixel based on a weighted sum of said at least one quantized historical current motion value for said present line pixel in said field occurring prior to said current output field.

21. The machine-readable storage according to claim 13, further comprising code for determining said output pixel value based on a final motion value for said output pixel.

22. The machine-readable storage according to claim 13, further comprising code for determining a final motion value for said output pixel based on said historical motion value for said output pixel and said current motion value for said output pixel.

23. The machine-readable storage according to claim 13, further comprising code for determining said current motion value for said output pixel based on a pixel constellation where all pixels are in a similar horizontal position as said output pixel.

24. The machine-readable storage according to claim 23, wherein said pixel constellation comprises:
a pixel in said current output field that is in a present line immediately above said output pixel;
a pixel in said current output field that is in a present line immediately below said output pixel;
a pixel that is in the same vertical position as said output pixel in a field occurring immediately prior to said current output field;
a pixel that is in the same vertical position as said output pixel in a field occurring immediately after said current output field;
a pixel that is in a present line immediately above the vertical position of said output pixel in a second field occurring after said current output field;
a pixel that is in a present line immediately below the vertical position of said output pixel in a second field occurring after said current output field; and
a pixel that is in the same vertical position as said output pixel in a third field occurring after said current output field.

25. A system for detecting motion using a pixel constellation, the system comprising:
at least one processor that defines an output pixel to be determined in a current output field; and
said at least one processor determines a value for said output pixel based on:
a current motion value for said output pixel; and
a historical motion value for said output pixel.

26. The system according to claim 25, wherein said at least one processor quantizes and stores in a memory said current motion value for said output pixel.

27. The system according to claim 25, wherein said at least one processor determines said historical motion value for said output pixel by reverse quantizing a quantized historical motion value for said output pixel.

28. The system according to claim 27, wherein said at least one processor determines said quantized historical motion value for said output pixel based on at least one quantized historical current motion value for a pixel in a present line in a field occurring prior to said current output field.

29. The system according to claim 27, wherein said present line pixel is at the same vertical and horizontal positions as said output pixel.

30. The system according to claim 27, wherein said present line pixel is in a present line pixel is immediately above or immediately below the vertical position of said output pixel and it is at the same horizontal position as said output pixel.

31. The system according to claim 27, wherein said at least one processor determines said quantized historical motion value for said output pixel based on a highest of said at least one quantized historical current motion value for said present line pixel in said field occurring prior to said current output field.

32. The system according to claim 27, wherein said at least one processor determines said quantized historical motion value for said output pixel based on a weighted sum of said at least one quantized historical current motion value for said present line pixel in said field occurring prior to said current output field.

33. The system according to claim 25, wherein said at least one processor determines said output pixel value based on a final motion value for said output pixel.

34. The system according to claim 25, wherein said at least one processor determines a final motion value for said output pixel based on said historical motion value for said output pixel and said current motion value for said output pixel.

35. The system according to claim 25, wherein said at least one processor determines said current motion value for said output pixel based on a pixel constellation where all pixels are in a similar horizontal position as said output pixel.

36. The system according to claim 35, wherein said pixel constellation comprises:
a pixel in said current output field that is in a present line immediately above said output pixel;
a pixel in said current output field that is in a present line immediately below said output pixel;
a pixel that is in the same vertical position as said output pixel in a field occurring immediately prior to said current output field;
a pixel that is in the same vertical position as said output pixel in a field occurring immediately after said current output field;
a pixel that is in a present line immediately above the vertical position of said output pixel in a second field occurring after said current output field;
a pixel that is in a present line immediately below the vertical position of said output pixel in a second field occurring after said current output field; and
a pixel that is in the same vertical position as said output pixel in a third field occurring after said current output field.
